(19) United States
(12) Patent Application Publication
(10) Pub. No.: US 2003/0146137 A1
(43) Pub. Date: Aug. 7, 2003

(54) Apparatus and method of soft sorting fruits and vegetables

(76) Inventors: Ronald A. Bichel, Juneau, WI (US); Thomas W. Bechert, Horicon, WI (US)

Correspondence Address: BOARDMAN, SUHR, CURRY & FIELD LLP, ATTN: IP PRACTICE GROUP, 1 SOUTH PINCKNEY STREET, FOURTH FLOOR, P.O. BOX 927, MADISON, WI, 53701-0927, US

(21) Appl. No.: 10/067,145

(22) Filed: Feb. 4, 2002

(51) Int. Cl. B07B 1/22

(52) U.S. Cl. 209/288; 209/683

(57) ABSTRACT

An apparatus and method for sorting a food product, such a fruit or vegetable, is disclosed. The food product to be sorted is introduced into a rotatable sorting chamber through an inlet opening. Whole and firm product is discharged out of the chamber through an outlet opening. Soft food product, on the other hand, is expelled radially out of the chamber through the sides of the chamber as the chamber rotates.

### FIELD OF THE INVENTION

The present invention relates generally to an apparatus and method of sorting food products. More specifically, it relates to an apparatus and method of sorting fruit or vegetable products, namely sorting soft, broken or undersized produce from whole, firm and acceptably sized produce.

### BACKGROUND OF THE INVENTION

Harvested food products, such as fruits or vegetables, received at a processing plant, typically include damaged and undamaged product, undersized product, and product that is either under ripe or overripe. In addition, foreign debris such as twigs, stones and dirt clods may also be included with the food product to be processed.

Whole and firm fruits and vegetables are typically processed for use as canned or frozen fruits and vegetables. Soft or broken produce, on the other hand, is either discarded as waste, or is used in making other food products, such as juices and sauces. For these reasons, soft or broken food product typically has less market value, if any, as compared with whole and firm food product It is common, therefore, to sort or separate out the soft or broken food product from the whole and firm food product.

Soft food product, as used herein, means that food product which is generally considered to be unacceptable for use in canned or frozen fruits or vegetables. Food product may be soft for a variety of reasons including as the result of disease, or as a result of being rotten or over ripe. Soft food product includes whole food product that is soft, but does not include broken or partial food product or pieces of food product.

Undamaged product or produce, as used herein, means product that is whole and firm. Damaged product or produce, on the other hand, as used herein, means product that is soft or broken. Acceptable or desirable product, as used herein, includes undamaged product as well as product that is generally considered to be acceptably sized. Unacceptable or undesirable product, as used herein, includes damaged product as well as product that is generally considered to be undersized and not acceptable for use in canned or frozen fruits or vegetables.

Not only is soft or broken (e.g., damaged) produce less desirable, it can also cause problems during processing if it is not properly removed from the processing line. This is especially true when lye peeling is used to remove the skin or peel from the food product being processed, such as in the case of tomatoes.

Soft and broken tomatoes have a tendency to disintegrate in the lye bath or lye solution that is used to loosen the skin on the tomatoes. Once they disintegrate, the juice from the disintegrated tomatoes contaminates the lye bath. This contamination dilutes the concentration of lye in the lye bath and the concentration falls below an effective level. Additional lye must be continuously added to the lye bath as a result to keep the concentration of lye at an effective level.

The need to continuously add lye to the lye bath increases processing costs. First, there is the cost of the additional lye that is required. Second, there is the added cost of waste disposal. As more lye is added to the lye bath, the lye bath solution overflows from its holding tank or lye applicator. The overflowing lye solution must either be flushed down the sewer or it must be hauled away for proper disposal off-site. Disposal of the excess lye solution can be expensive and can also add to the overall cost of processing the food product. For these reasons, it is generally desirable to sort out soft or broken tomatoes from firm and whole tomatoes prior to the lye peeling stage.

The sorting of fruits and vegetables during processing has traditionally been done by hand. The food product to be sorted is transported by conveyor through an inspection area or zone where workers manually remove foreign debris and soft, broken or undersized product from the food product passing by on the conveyor. The whole, firm and acceptably sized produce continues down the line for further processing such as peeling, scrubbing and washing. The undesirable product, including the damaged product, is removed from the conveyor and is either discarded or is collected for further processing separate from the desirable food product.

The manual sorting process described above is problematic in several regards. Manual sorting is labor intensive and therefore expensive to perform. In addition, workers often miss undesirable product as it passes through the inspection and sorting zones. This is especially true for soft product which generally will not exhibit any visual indications that the product is soft. Thus, a significant amount of soft product is never separated out from the rest of the food product passing through the manual sorting area.

Automatic sorters have been developed to address some of the concerns and problems regarding manual sorting operations. These prior art sorters typically use flat conveyors having specially configured rollers. The rollers are arranged transverse to the direction of flow of the food product and are spaced apart from each other so as to allow broken and smaller product to fall between adjacent rollers. In essence, these prior art systems are akin to size grading systems. These prior art systems sort based on product size and not based on firmness As a result, undersized product and some small broken product is removed Larger soft product, however, generally passes through these prior art automatic sorting apparatuses undetected and continues down the line for further processing.

It is desirable, therefore, to have an apparatus and method for reliably removing soft or broken food product, such as soft or broken tomatoes, from the line before the food product enters the lye bath. It is also desirable to have an apparatus and method for reliably removing foreign debris from the food product, such as twigs, stones and dirt clods. Preferably, the apparatus and method will have the capability to sort out substantially all of the soft food product from the firm food product. The sorting apparatus will preferably also have the capability to sort small and undersized product from acceptably sized product.

### SUMMARY OF THE PRESENT INVENTION

According to a first aspect of the invention, an apparatus for separating soft food product from firm food product includes a rotatable cage having a chamber, a first roller and a second roller. The chamber rotates about a main axis of rotation. The first roller is radially disposed on the perimeter of the chamber and has a seconds axis of rotation. The first roller orbits about the main axis of rotation and rotates about the second axis of rotation in a first direction. The second roller is also radially disposed on the perimeter of the chamber immediately adjacent the first roller and has a third axis of rotation. The second roller orbits about the main axis of rotation and rotates about the third axis of rotation in a second direction opposite to the first direction. The soft food product is removed from the rotating chamber by the first and second counter-rotating rollers.

The chamber has a product inlet opening at a first end of the chamber for receiving food product to be sorted in one embodiment and has a product outlet opening at a second end of the chamber opposite the first end for delivering firm food product out of the chamber in another embodiment. The main axis of rotation slopes downward from the inlet opening to the outlet opening in one other embodiment. The apparatus includes a drive unit disposed to drive the rotatable cage in another embodiment.

In one embodiment, the first and second rollers are each covered with a gripping material while in another embodiment, they are each brush rollers. In one other embodiment, the first roller is covered with a gripping material and the second roller is a brush roller. The first roller is a brush roller and the second roller is smooth in another embodiment.

According to a second aspect of the invention, an apparatus for sorting a food product, such as a fruit or vegetable, includes a chamber and a plurality of rollers radially spaced apart around the circumference of the chamber. Each of the rollers includes a pinion gear. A first ring gear engages with every other one of the plurality of pinion gears to rotate every other one of the plurality of rollers in a first direction. A second ring gear engages with the other ones of the plurality of pinion gears to rotate the other ones of the plurality of rollers in a second direction opposite to the first direction.

The first ring gear is an external ring gear in one embodiment and the second ring gear is an internal ring gear in another embodiment. The chamber includes a receiving end disposed to receive the food product to be sorted into the chamber in one embodiment and includes a discharge end disposed to deliver sorted food product out of the chamber in yet another embodiment.

According to a third aspect of the invention an apparatus for sorting a food product, such as a fruit or vegetable, includes a first plurality of rollers and a second plurality of rollers. The first and second plurality of rollers are each radially disposed about a first axis of rotation, and each of the first and second plurality of rollers includes a pinion gear. The first and second plurality of rollers define a chamber for receiving the food product to be sorted. A first ring gear engages with each of the pinion gears attached to the first plurality of rollers to impart rotation to the first plurality of rollers in a first direction. A second ring gear engages with each of the pinion gears attached to the second plurality of rollers to impart rotation to the second plurality of rollers in a second direction opposite to the first direction.

In one embodiment, the first ring gear is an external ring gear and in another embodiment, the second ring gear is an internal ring gear. The chamber has a product inlet opening at a first end for receiving food product to be sorted in another embodiment and has a product outlet opening at a second end opposite the first end for delivering sorted food product out of the chamber in yet one other embodiment.

According to a fourth aspect of the invention, an apparatus for sorting soft food product from firm food product includes a cage having a chamber rotatable about a main axis and a plurality of rollers radially spaced apart around the circumference of the chamber. Adjacent rollers from the plurality of rollers rotate in opposite directions as the chamber rotates around the main axis to pull soft food product radially out of the chamber.

The chamber has a product inlet opening at a first end of the cage for receiving food product to be sorted in one embodiment and has a product outlet opening at a second end of the chamber opposite the first end for delivering firm food product out of the chamber in another embodiment. The main axis slopes downward from the inlet opening to the outlet opening in one other embodiment and the apparatus includes a drive unit disposed to drive the rotatable chamber in yet one other embodiment.

Each of the plurality of rollers is covered with a gripping material in one embodiment while each of the plurality of rollers is a brush roller in another embodiment. Adjacent pairs of rollers from the plurality of rollers include both a brush roller and a smooth roller in one embodiment and both a brush roller and a gripping roller in another embodiment.

According to a fifth embodiment of the present invention, an apparatus for sorting a food product such as a fruit or vegetable includes a plurality of rotatable rollers arranged in radially spaced-apart relationship about a main axis of rotation so as to define a chamber for receiving the food product to be sorted. Each of the plurality of rollers orbits about the main axis of rotation and each of the plurality of rollers has its own axis of rotation. Adjacent rollers from the plurality of rollers rotate about their own axis of rotation in opposite directions to remove soft food product from the chamber.

According to a sixth aspect of the invention, an apparatus for sorting soft food product from firm food product includes a product sorting chamber rotatable about a main axis. The chamber is configured to expel substantially all of the soft food product radially outward from the chamber as the chamber rotates.

In one embodiment, the chamber includes a discharge end and the chamber is configured to discharge substantially all of the firm product out of the chamber through the discharge end as the chamber rotates. In another embodiment, an inlet opening is included at a first end of the chamber for receiving food product to be sorted into the chamber. An outlet opening is included at a second end of the chamber opposite the first end for delivering firm food product out of the chamber in one other embodiment.

According to an seventh aspect of the invention an apparatus for sorting soft food product from firm food product includes a generally cylindrical product sorting chamber rotatable about a main axis. The chamber is configured to expel at least 50 percent of the soft food product radially outward from the chamber as the chamber rotates.

In one embodiment, the chamber includes a discharge end and the chamber is configured to discharge firm product out of the chamber through the discharge end as the chamber rotates.

According to a eighth aspect of the invention, a method of sorting soft food product from firm food product includes introducing the food product to be sorted into a rotating chamber and expelling soft food product out of the chamber between first and second counter-rotating rollers. The counter-rotating rollers are radially disposed about the rotating chamber.

In one embodiment, firm food product is delivered out of an end of the rotating chamber. The chamber rotates at a speed in the range of 25 to 30 revolutions per minute (rpms) in another embodiment and rotates at a speed of less than 35 rpms in one other embodiment.

According to a ninth aspect of the invention, a method of separating soft food product from firm food product includes rotating a chamber having a receiving end and a discharge end. The food product to be sorted is introduced into the chamber at the receiving end. The firm food product is allowed to pass out of the chamber at the discharge end. The soft food product is allowed to pass out of the cage through counter-rotating rollers radially disposed around the circumference of the chamber.

In one embodiment, the chamber rotates at a speed in the range of 25 to 30 rpms. The chamber rotates at less than 35 rpms in another embodiment.

According to an tenth aspect of the invention, a method of separating soft food product from firm food product includes passing soft food product through a pair of counter-rotating rollers as the pair of counter-rotating rollers orbit in a 360 degree path about a central axis of rotation.

According to an eleventh aspect of the invention, a method of separating soft food product from firm food product includes rotating a chamber about a main axis. The food product to be sorted is introduced into the chamber. Substantially all of the soft food product is radially expelled out of the chamber In one embodiment, the food product to be sorted is introduced into a receiving end of the chamber. The firm food product is discharged out of a discharge end of the chamber in another embodiment. Substantially all of the firm food product is discharged out of a discharge end of the chamber in yet another embodiment.

In one embodiment, soft food product is radially expelled from only the lower one-half of the chamber as the chamber rotates and is expelled from only the lower two-thirds of the chamber as the chamber rotates in another embodiment. The soft food product is radially expelled from the chamber as the chamber rotates at less than 35 rpms in another embodiment.

Other principal features and advantages of the invention will become apparent to those skilled in the art upon review of the following drawings, the detailed description and the appended claims.

### BRIEF DESCRIPTION OF THE DRAWINGS

FIG. 1 shows an isometric view of a sorting apparatus according to one embodiment of the present invention;

FIG. 2 shows a side view of the sorting apparatus of FIG. 1 with the housing removed;

FIG. 3 shows an end view of the discharge end of the sorting apparatus of FIG. 1;

FIG. 4 shows an end view of the drive end of the sorting apparatus of FIG. 1;

FIG. 5 shows a close-up side view of the drive end of the sorting apparatus of FIG. 1 with the housing removed;

FIG. 6 shows a close-up end view of the drive end of the sorting apparatus of FIG. 1 with the housing removed;

FIG. 7 shows a close-up, cross-sectional view of a portion of the planetary gears located at the drive end of the sorting apparatus of FIG. 1 with an internal pinion gear shown;

FIG. 8 shows a close-up, cross-sectional view of a portion of the planetary gears located at the drive end of the sorting apparatus of FIG. 1 with an external pinion gear shown; and

FIG. 9 shows a close-up view of several of the rollers of the sorting apparatus of FIG. 1 during operation.

Before explaining at least one embodiment of the invention in detail it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. Like reference numerals are used to indicate like components.

### DETAILED DESCRIPTION OF THE PREFERRED EMBODIMENTS

While the present invention will be illustrated with reference to a particular apparatus having a particular configuration and particular features, the present invention is not limited to this configuration or to these features and other configurations and features can be used. Likewise, although the present invention will be illustrated with reference to a particular process having particular process steps, the invention is not limited to those steps and other steps can be included or deleted. Finally, although the present invention will be illustrated with reference to sorting fruits and vegetables, including tomatoes, the present invention is not limited to sorting tomatoes, nor is it limited to sorting fruits or vegetables. In fact, the present invention may be used to sort other food products and non-food related objects as well.

Generally, the present invention involves an apparatus and method of sorting soft or broken food product, such as soft or broken tomatoes, peaches or pears, from whole and firm food product. It should be noted that the invention is not limited to sorting tomatoes, peaches or pears. The present invention may also be used to sort other fruits and vegetables as well.

Product is received into a sorting chamber through an inlet opening. Undamaged product, namely firm and whole product, is discharged from the chamber through an outlet opening. The inlet opening is located at one end of the chamber and the outlet opening is located at the other end of the chamber in one embodiment. Damaged product, namely soft or broken product, on the other hand, is expelled radially from the sides of the chamber as the chamber rotates. The process for removing soft food product from the chamber in this embodiment is waterless.

In one embodiment, counter-rotating rollers are used to remove soft food product from the chamber. The rollers grip the soft food product and pull it out of the chamber. Whole and firm food product, on the other hand, is not gripped by the rotating rollers and therefore is not expelled out of the sides of the chamber. Depending on the food product to be sorted, more or less aggressive (e.g., type of gripping surface) rollers can be used to grab and hold onto the soft food product to be removed from the chamber.

It should be noted that in other embodiments, other structures or devices may be used to grip, hold and/or expel the soft food product radially outward from the sides of the rotating chamber. In other words, the present invention is not necessarily limited to the use of rollers or counter-rotating rollers.

The invention includes a rotating cage or drum having a generally cylindrical sorting chamber disposed about a main longitudinal axis in one embodiment. An inlet opening is located at one end of the chamber and a discharge opening is located at the opposite end of the chamber in one embodiment. A plurality of rotating rollers or brushes are radially disposed in spaced-apart relationship about the main axis and define the outer radial perimeter (e.g., sides) of the sorting chamber. The main longitudinal axis of the chamber slopes downward from the inlet opening to the discharge opening in one embodiment to help advance the product through the chamber. The main horizontal axis is horizontal in other embodiments.

During operation, the entire cage, including the chamber, rotates about the main longitudinal axis. The cage can either rotate in the clockwise direction or the counter-clockwise direction in one embodiment. The plurality of rollers orbit about the main axis with the cage as the cage rotates. In addition to orbiting about the main axis, each of the rollers also rotates about its own axis. Adjacent rollers rotate about their own axis in opposite directions. Thus, the plurality of rollers spaced around the perimeter of the chamber can be broken down into a plurality of counter-rotating roller pairs. Each counter-rotating roller pair includes two rollers that rotate towards each other when viewed from the inside of the chamber.

Counter-rotating, as used herein, means rotating in opposite directions. For example, with respect to two counter-rotating rollers, if one of the rollers rotates in the clockwise direction, the other roller rotates in the counter-clockwise direction. Orbit, as used herein with respect to an object, means to revolve around the axis of another object. Rotate, as used herein with respect to an object, means to revolve or spin around the object's own axis.

The product to be sorted is introduced into the chamber at the inlet end. The product generally enters at the bottom of the chamber and is pulled upward along the inside surface of the chamber (e.g., the inside surface or circumference of the chamber is defined by the rotating surfaces of the counter-rotating rollers) by the rotating cage and the counter-rotating rollers. Once the product reaches a certain height inside of the rotating chamber, gravity causes it to tumble back to the bottom of the chamber. The product continues to rise and fall as it makes its way through the sorting chamber from the inlet end to the discharge or outlet end of the chamber.

In one embodiment of the present invention having a counter-clockwise rotating chamber, the product travels upward to approximately the 3 o'clock position (e.g, travels about 90 degrees around the chamber) before it tumbles back to the bottom of the chamber. In another embodiment of the present invention having a chamber rotating in the clockwise direction, the product travels upward to approximately the 9 o'clock position.

Undamaged product, that is product that is whole and firm, generally remains in the chamber and continues to tumble as it moves from the inlet end of the chamber to the discharge end of the chamber At the discharge end, the undamaged product is discharged out of the chamber for further processing, such as for lye peeling.

Damaged product (e.g., product that is soft or broken), on the other hand, is pulled out of the chamber by the various pairs of counter-rotating rollers before it reaches the discharge end. The damaged product expelled from the sides of the chamber between the counter-rotating rollers drops to a conveyor belt located beneath the chamber in one embodiment where it is carried away for disposal or further processing.

In one embodiment of the present invention, substantially all of the soft food product is sorted out from the firm food product. In another embodiment, fifty percent of the soft food product is sorted out from the firm food product. In other embodiments, more than fifty percent, less than fifty percent, or a desired amount of soft food product is sorted out from the firm food product.

It should be noted that desired amount or quantity of sorted food product, as used herein with respect to the amount or quantity of soft or damaged food product sorted or separated out from firm and undamaged product, for a particular application utilizing a sorting apparatus or method according to the present invention, includes that amount or quantity of sorted product that will allow the apparatus or method to be used for its intended purpose in that particular application. Desired amount or quantity of sorted product may be a range of values and may vary from application to application depending on the specifics of the application.

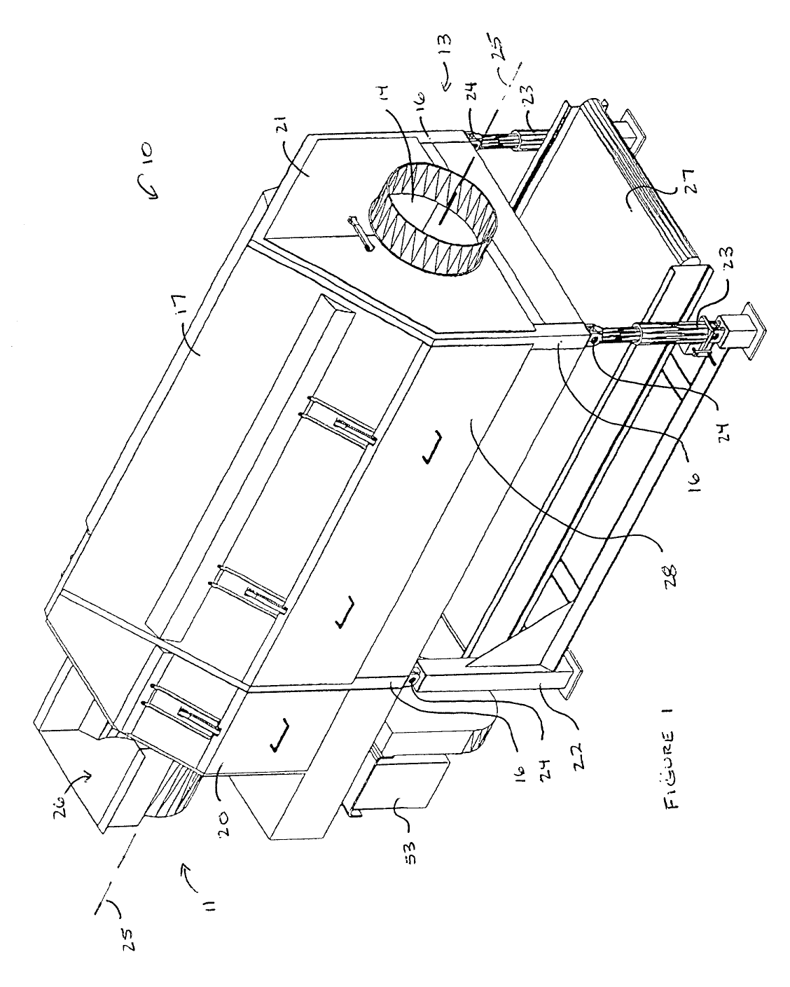

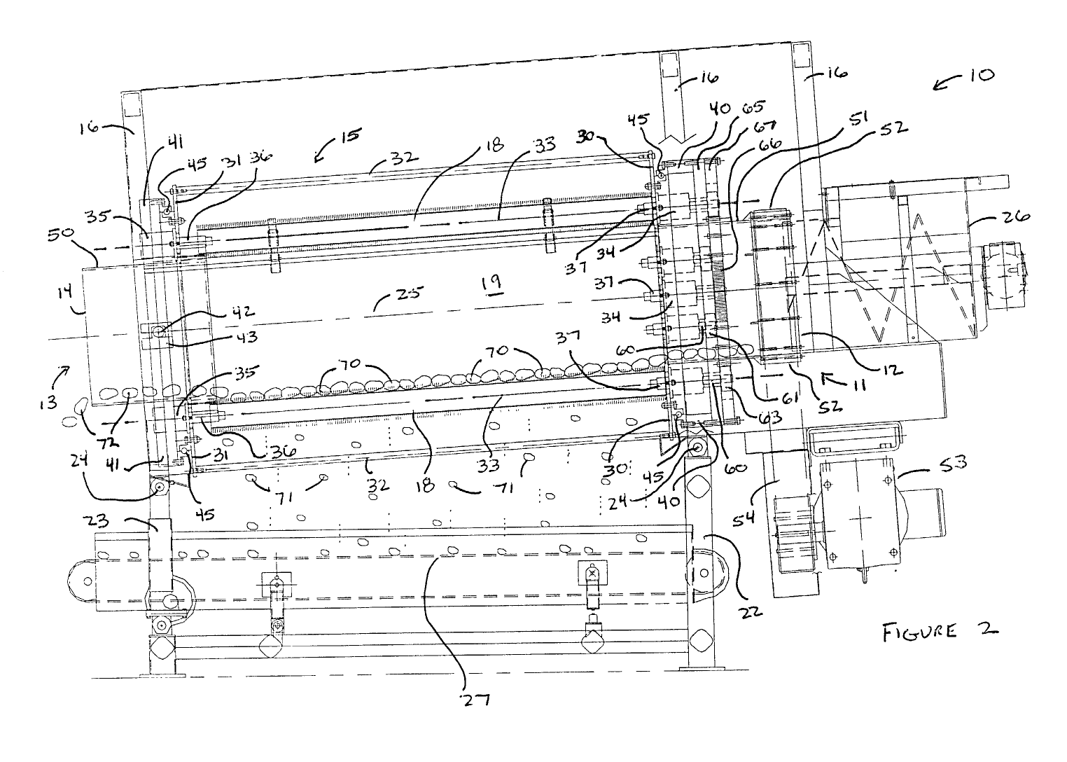

FIG. 1 generally shows a sorting apparatus 10 according to one embodiment of the present invention. Sorting apparatus 10 includes a drive or inlet end 11 having an inlet opening 12, a discharge or outlet end 13 having an outlet opening 14 and a rotatable cage or drum 15 (see FIG. 2) rotatably mounted between drive end 11 and discharge end 13. Cage 15 is rotatably mounted to a support frame 16 and is enclosed inside of a housing 17. In an alternative embodiment of the present invention, a single opening is used for both receiving and discharging product from the chamber

Access doors 28 are provided on the sides of housing 17 to permit easy access to rotatable cage 15 and the plurality of rollers 18 that define sorting chamber 19 (see FIG. 2). Similarly, a second set of access doors 20 are provided on the sides of housing 17 near drive end 11 to provide access to the planetary gears and drive mechanism that drive rotatable cage 15 and rollers 18. Finally, access doors 21 are provided on discharge end 13 for accessing the end of rotatable cage 15.

Sorting apparatus 10 is supported by two legs 22 under drive end 11 and by two jack stands 23 located under discharge end 13. Support frame 16 is pivotly connected to legs 22 and jack stands 23 at four pivot points 24. Jack stands 23 can be adjusted to raise or lower discharge end 13 of sorting apparatus 10, thereby providing for adjustment of the downward slope of cage 15 between inlet end 11 and outlet end 13 (e.g., the slope of longitudinal main axis 25).

In general, the greater the slope of main axis 25 from horizontal, the faster the product will advance through sorting chamber 19. Thus the slope of chamber 19 is one parameter that can be adjusted to optimize the overall performance of sorting apparatus 10. In general, the slope of chamber 19 will vary depending on the type and condition of the food product to be sorted. For example, the inventors have found that for a 48 inch long cage, a downhill pitch of about 3 to 4 inches works well for sorting tomatoes. This is equivalent to a slope of approximately 3.5 to 5 degrees from horizontal. In other embodiments, however, other slopes can be used including slopes that are less than 3.5 degrees and that are greater than 5 degrees.

An infeed auger 26 is also shown in FIG. 1 at drive end 11 of cage 15. Auger 26 is provided in this embodiment to feed the food product to be sorted through inlet opening 12 and into chamber 19. In alternative embodiments, the product is fed evenly into a chute aligned with inlet opening 12 while in another embodiment, a conveyor delivers the food product to be sorted to inlet opening 12.

Also shown in FIG. 1 is a conveyor 27 positioned underneath rotatable cage 15 between legs 22 and jack stands 23. Conveyor 27 is provided to collect the soft, broken or undersized food product, as well as any unwanted debris, that is expelled radially out of the sides of chamber 15 through counter-rotating rollers 18. Conveyor 27 conveys the collected material away for further processing or for disposal as the case may be.

It should be noted that in other embodiments of the present invention, no conveyor is provided beneath sorting apparatus 10. For example, in another embodiment, a waste tray is provided to collect the waste material expelled from the chamber instead of a conveyor. In other embodiments of the present invention, no conveyor or waste tray is provided.

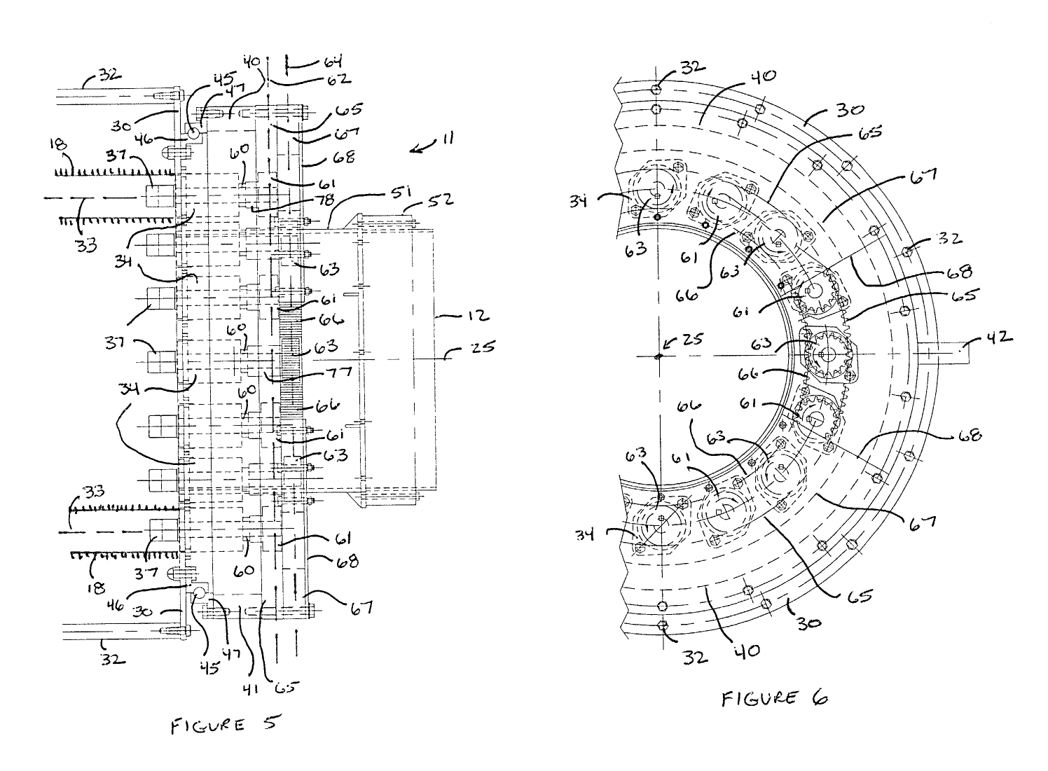

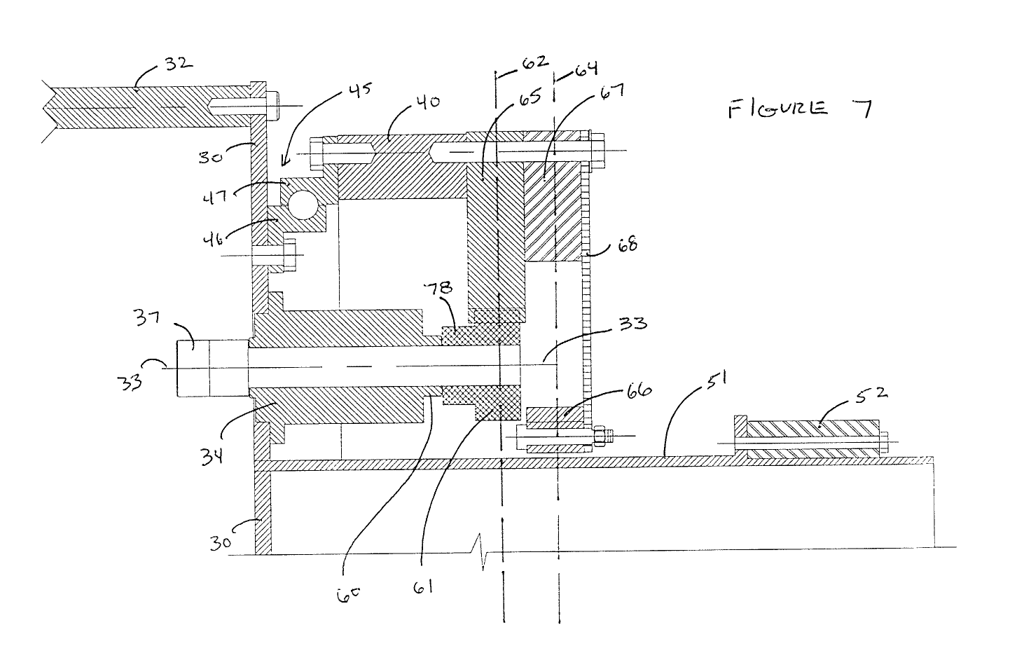

FIG. 2 shows a side view of sorting apparatus 10 with housing 17 removed while FIGS. 5 and 6 show close-up views of the drive end of sorting apparatus 10 with housing 17 removed. Rotatable cage or drum 15 as illustrated in this embodiment includes a first cylindrical drive plate 30 located at drive end 11 of cage 15 and a second cylindrical drive plate 31 located at discharge end 13 of cage 15. A plurality of longitudinal struts 32 equally spaced around the perimeter of each drive plate 30, 31 connect the two drive plates together In the embodiment shown in FIGS. 5 and 6, for example, sixteen (16) such struts 32 are equally spaced around the perimeter of cage 15. In other embodiments, more or less struts are provided or some other type of structure or structures is used to connect the drive plates with each other.

A plurality of rollers or brushes 18 are rotatably mounted between drive plates 30, 31 in spaced apart relationship about main longitudinal axis 25. The plurality of rollers 18 are located on, and define, the inside surface or radial perimeter of sorting chamber 19 which is located inside of rotating cage 15. As cage 15 rotates about main longitudinal axis 25, each of the plurality of rollers 18 rotates with cage 15 about main axis 25. More precisely, each of the rollers 18 orbits a full 360 degrees (e.g., in a full circle) about main axis 25 as cage 15 rotates. In addition to orbiting about main axis 25, each of the rollers 18 also rotates about its own axis of rotation 33 as it orbits about main axis 25. Adjacent rollers 18 rotate about their own axis 33 in opposite directions in this embodiment.

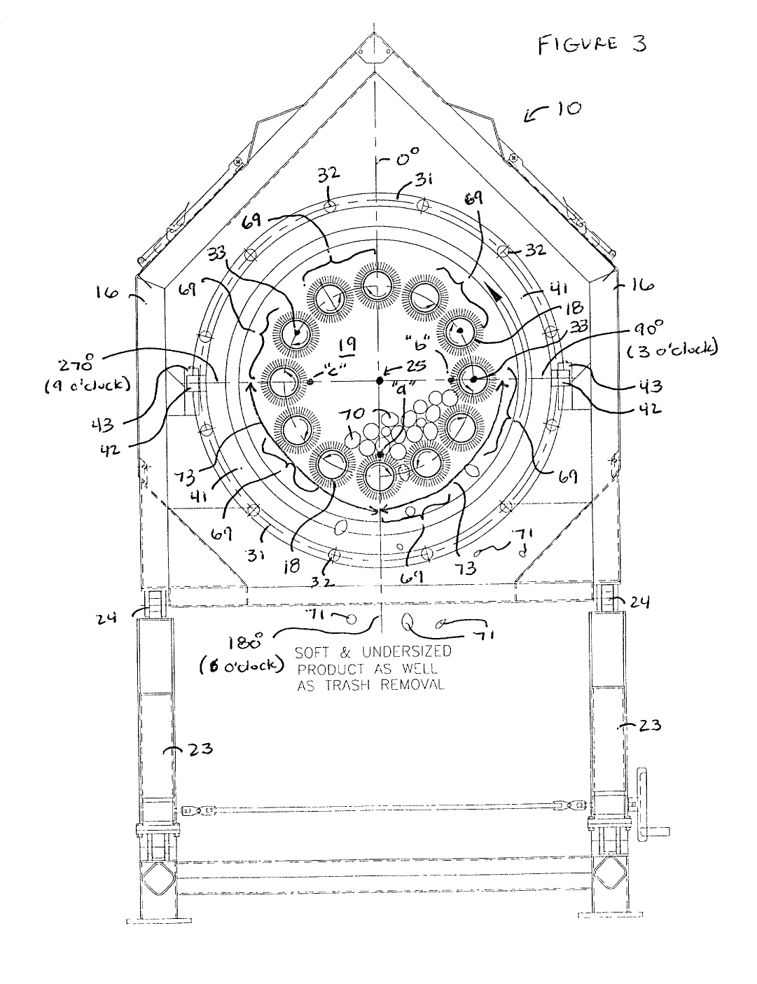

In one embodiment of the present invention, sixteen (16) rollers or brushes are rotatably mounted between drive plates 30, 31 (see FIG. 6). The radius of the cage having 16 rollers in this embodiment, as measured from main axis 25 to the axis 33 of each roller 18 is 13.6 inches. In other embodiments, 8 brushes or 12 brushes are provided (see FIG. 3). In yet other embodiments of the present invention, more or less rollers or brushes are included around the perimeter of the sorting chamber including less than eight brushes and more than sixteen brushes.

The rollers 18 are rotatably mounted inside of cage 15 in the following manner in one embodiment. Each drive plate 30, 31 includes a plurality of openings for receiving and mounting a plurality of bearing cartridges 34, 35 therein. Bearing cartridges 34, 35 are mounted to drive plates 30, 31 using conventional hardware such as conventional bolts. Each bearing cartridge 35 mounted to drive plate 31 on discharge end 13 of cage 15 includes a keyed spindle 36 extending inward toward cage 15 and parallel to main axis 25. Likewise, each bearing cartridge 34 mounted to drive plate 30 located on drive end 11 of cage 15 also includes a keyed spindle 37 extending inward toward cage 15 and parallel to main axis 25. Each of the inwardly directed spindles 36 on the discharge end 13 of cage 15 are aligned with a corresponding inwardly directed spindle 37 on drive end 11 of cage 15. Mounted between drive plates 30, 31 on each pair of aligned spindles is a roller or brush 18 as shown in FIG. 2. Since each roller 18 is mounted at its ends to drive plates 30, 31 by way of bearing cartridges 34, 35, each roller 18 is free to rotate about its own axis 33.

Cage 15 is rotatably mounted to support frame 16 in the following manner (see FIGS. 2, 7 and 8). A first trunnion ring 40 is fixedly mounted to support frame 16 at drive end 11 of sorting apparatus 10. Similarly, a second trunnion ring 41 is fixedly mounted to support frame 16 at discharge end 13 of sorting apparatus 10. Each trunnion ring 40, 41 includes a pair of trunnion ring support shafts 42, one on each side of the trunnion ring. The trunnion ring support shafts 42 are fixedly received in trunnion ring mounting brackets 43 that are fixedly attached to the upright support members on each side of support frame 16.

Each drive plate 30, 31 of cage 15 is in turn rotatably mounted to a corresponding one of fixed trunnion rings 40,41 using a ring shaped main bearing assembly 45. Each main bearing assembly 45 is comprised of a first L-shaped flange 46 that is fixedly mounted to the drive plates 30, 31 and a second overlapping L-shaped flange 47 that is fixedly mounted to the trunnion rings 40, 41. A plurality of ball bearings are located between each of the two L-shaped flanges to complete each main bearing assembly 45. Thus, cage 15 rotates inside of support frame 16 on the two main bearings 45, one of which is located on the drive end of sorting apparatus 10 and the other of which is located on the discharge end of sorting apparatus 10.

In addition to having a plurality of bearing cartridges mounted thereto, each drive plate also has a tube welded thereto. For example, drive plate 31 at discharge end 13 has a discharge tube 50 welded to it to define the outlet opening 14 through which the sorted product is delivered. Similarly, drive plate 30 at drive end 11 also has a tube 51 welded to it. Tube 51 is disposed about, and defines, inlet opening 12.

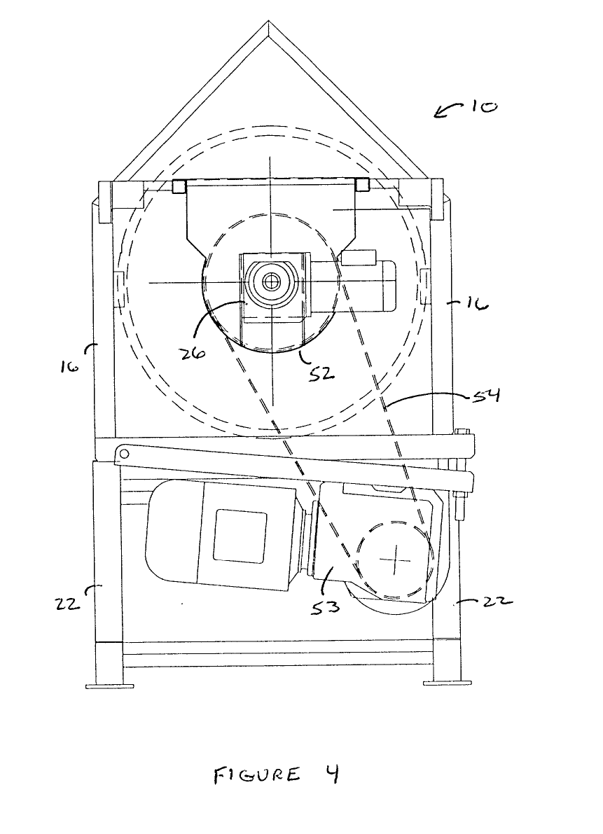

Tube 51 not only defines the inlet opening to chamber 19, but is also used to drive rotatable cage 15. A sprocket or pulley 52 is attached to drive tube 51 and is connected to a drive unit 53 located below drive tube 51. Drive unit 53 in this embodiment is a gear motor assembly that drives rotatable cage 15 via a cog belt 54 (see FIG. 4). The present invention is not limited to the use of gear motors and belts, however, and other types of drive units and driving mechanisms could be used. For example, in other embodiments, cage 15 is driven using chains and sprockets.

As previously discussed, each of the rollers 18 orbits about main longitudinal axis 25 as cage 15 rotates. In addition, however, each roller 18 also rotates about its own axis 33. Rotation of each roller 18 is accomplish using a planetary gear arrangement as is best shown in FIGS. 5-6.

Each bearing cartridge 34 on drive end 11 of sorting apparatus 10 includes a second spindle 60 that protrudes outwardly away from cage 15 and parallel to main axis 25. Mounted on the end of each outwardly directed spindle 60 is a pinion gear. The hubs 77, 78 attached to each pinion gear are of two lengths, with every other pinion gear having a hub that is longer than the hub on the two pinion gears immediately adjacent on either side. As a result, half of the outwardly directed pinion gears extend further out from their bearing cartridges 34 than do the other half of the pinion gears. In an alternative embodiment, spindles 60 are of two different lengths and the hubs on the pinion gears are all the same length.

The pinion gears having the shorter hubs 78 are referred to as internal pinion gears 61. Internal pinion gears 61 are all located in a first plane 62 that is perpendicular to main longitudinal axis 25 in this embodiment. The pinion gears having the longer hubs 77, on the other hand, are referred to as external pinion gears 63. External pinion gears 63 are all located in a second plane 64 that is parallel to first plane 62 but positioned further away from the drive end of cage 15 as compared to first plane 62.

In addition to pinion gears 61, 63, a pair of ring gears are also present on drive end 13 of sorting apparatus 10. The first of these ring gears is an internal ring gear 65 that is fixedly mounted to the outside surface of trunnion ring 40. Internal ring gear 65 is located in the same plane 62 as internal pinion gears 61 and meshes with each internal pinion gear 61. The second of the ring gears is an external ring gear 66 that is also fixedly mounted in sorting apparatus 10. External ring gear 66 is disposed in the same plane 64 as the plurality of external pinion gears 63 and meshes with each external pinion gear 63.

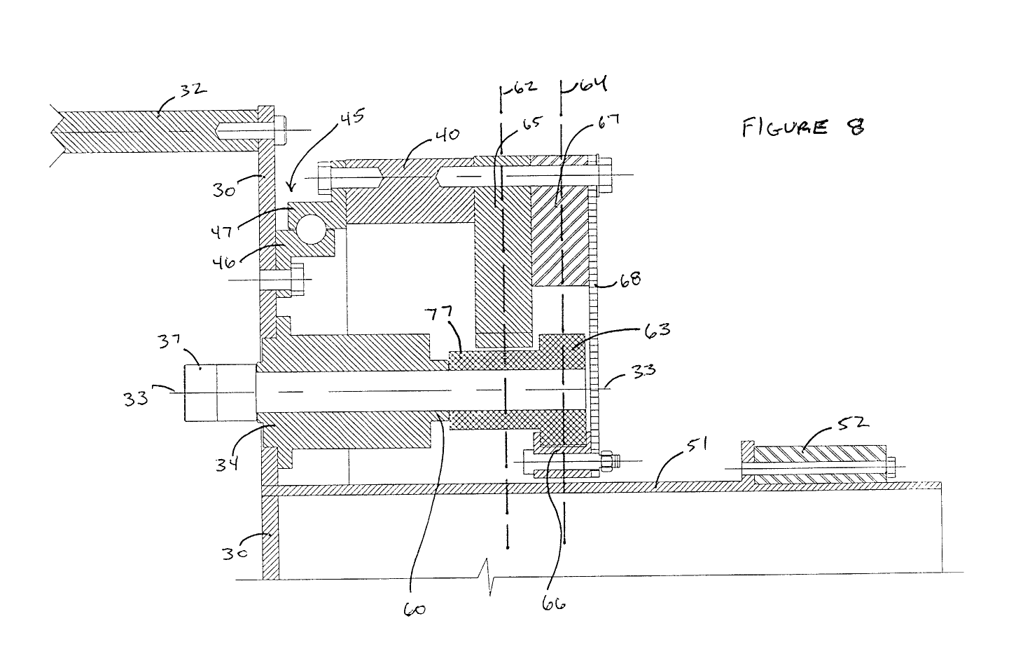

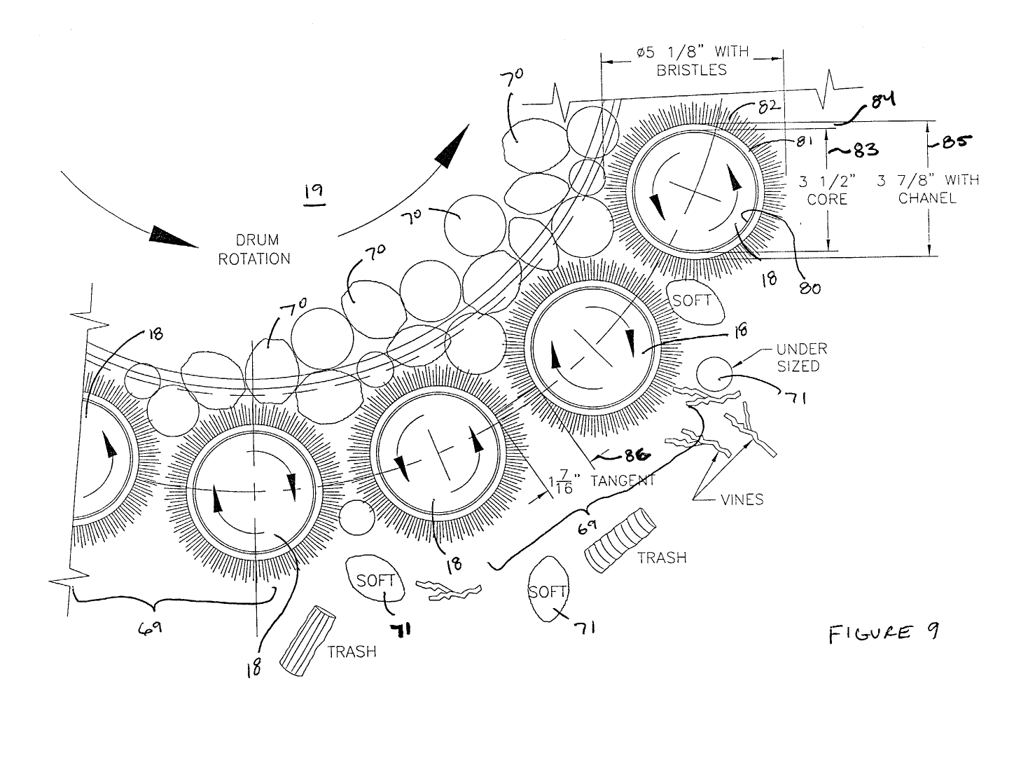

External ring gear 66 is fixedly mounted in sorting apparatus 10 in the following manner which is best shown in FIGS. 7-8. As previously mentioned, internal ring gear 65 is mounted to the outside surface of trunnion ring 40. Two spacer plates 67, each extending approximately 120 degrees around the circumference of internal ring gear 65 are mounted to the outer surface of internal ring gear 65. One of the spacer plates 67 is mounted at the top center of internal ring gear 65 and the other is mounted at the bottom center of internal ring gear 65. In an alternative embodiment, one spacer plate that extends 360 degrees around main axis 25 is used instead of two separate spacer plates.

A pair of external ring gear mounting plates 68 are mounted to the outer surface of each spacer plate 67. Like spacer plates 67, each mounting plate 68 only extends approximately 120 degrees around the circumference of internal ring gear 65. One of the mounting plates 68 is mounted at the top center and the other is mounted at the bottom center of sorting apparatus 10.

Each mounting plate 68 extends inward toward main longitudinal axis 25 beyond spacer plates 67. External ring gear 66 is mounted to the inside surface of mounting plates 68. Spacer plates 67 are merely provided to assure that external ring gear 66 is properly aligned for engagement with external pinion gears 63 when it is attached to mounting plates 68.

The planetary gear system described above operates in the following manner to provide for counter-rotation of rollers 18 as cage 15 rotates. As cage 15 rotates in one direction (either clockwise or counterclockwise), each of the pinion gears 61, 63 orbits around main axis 25 in the same direction as cage 15. As they orbit, each of the internal pinion gears 61 in first plane 62 mesh with, or engage internal ring gear 65. Thus, as rotatable cage 15 rotates in one direction, each internal pinion gear 61, and each roller 18 driven by the pinion gear, travels around the inside surface of fixed internal ring gear 65. The meshing or engagement of each internal pinion gear 61 with internal ring gear 65 causes each internal pinion gear 61, and the rollers 18 attached to these pinion gears, to rotate in a direction that is opposite to the direction of rotation of cage 15.

In a similar manner, as cage 15 rotates about main axis 25, each of the external pinion gears 63 located in second plane 64 mesh with, or engage external ring gear 66. Thus, as rotatable cage 15 rotates, each external pinion gear 63, and each roller 18 driven by those pinion gears, travels around the outside surface of fixed external ring gear 66. The meshing or engagement of each external pinion gear 63 with external ring gear 66 causes each external pinion gear 63, and the rollers 18 attached to these pinion gears, to rotate in a direction that is the same as the direction of rotation of cage 15 or in a direction that is opposite or counter to the direction of rotation of internal pinion gears 61 and the rollers 18 attached thereto

In this way, as cage 15 rotates in one direction, adjacent pinion gears 61, 63 and the rollers 18 driven by those pinion gears, are driven in opposite directions with respect to each other by ring gears 65 and 66. In other words, ring gears 65, 66 impart rotation to rollers 18 through pinion gears 61, 63 respectively in this embodiment. Thus, the sorting chamber is surrounded by counter-rotating pairs 69 (see FIGS. 3 and 9) of rollers. It should be noted that counter-rotating roller pairs 69 have rollers which rotate towards each other when viewed from the inside of chamber 19. These counter-rotating pairs of rollers grab and pull soft food product between the rollers and out of the sorting chamber.

In one embodiment of the present invention having 16 rollers and a cage radius of 13.6 inches, 3.2 inch pitch diameter pinion gears are used. In this embodiment, cage 15 (and chamber 19) rotates at 27 revolutions per minute (rpms) around main axis 25. Each pinion gear 61, 63 and roller 18 attached thereto in this embodiment rotates at 256.5 rpms about its own axis 33.

The present invention is not limited to the above configuration, however. In other embodiments, more or less rollers 18 are used (e.g., 8, 12, etc. . . . ), the cage has a greater or smaller radius, or pinion gears having other pitch diameters are used. For example, in other embodiments, pinion gears 61, 63 have 2.3 inch pitch diameters or 4.5 inch pitch diameters.

It should also be noted that other drive mechanisms can be used to impart rotation to rollers 18. The invention is in no way limited to the use of pinion gears and ring gears. For example, in an alternative embodiment belts and pulleys are used. In another embodiment, chains and sprockets are used to impart counter-rotation to rollers 18.

The present invention is also not limited to having all of the planetary gears on the drive end of the sorting apparatus. In an alternative embodiment, for example, the internal pinion gears and the internal ring gear are located on one end of the sorting apparatus (inlet end or outlet end) and the external pinion gears and the external ring gear are locate on the other end of the sorting apparatus.

The operation of sorting apparatus 10 according to one embodiment of the present invention will now be described in detail. The food product 70 (see FIGS. 2, 3 and 9) to be sorted, in this case tomatoes, is introduced through inlet opening 12 and into sorting chamber 19. This can be accomplished either by use of an auger feeding device, a conveyor or by manually feeding the product to be sorted into a chute aligned with inlet opening 12.

Product 70 will typically be introduced into the bottom of chamber 19 at or about position “a” in FIG. 3 (e.g., about at a position that is 180 degrees from the top of chamber 19 or that is at a six o'clock position). The product is introduced at a rate that will result in only a single layer of product forming on the bottom of chamber 19 near inlet end 12 in one embodiment. In other embodiments, the product is introduced at rates that will allow for more than one layer of product to form on the bottom of chamber 19 near inlet end 12, such as two or three layers of product. The rate at which product is introduced into the chamber is another parameter that can be adjusted to achieve a desired level of performance from the sorting operation depending on the particular product and condition of the product to be sorted.

Product 70 so introduced into the sorting chamber is drawn up along the inside surface of the chamber (defined by rollers 18) both by the centrifugal force of rotating chamber 19 and by the gripping force of the counter-rotating pairs of rollers 69 that line the perimeter (e.g., sides) of chamber 19. The chamber shown in FIGS. 3 and 9 rotates in the clockwise direction. In an alternative embodiment, the chamber rotates in a counter-clockwise direction.

As chamber 19 rotates, the product continues to rise along the inside surface of the chamber until gravity overcomes the centrifugal force and gripping force of the counter-rotating pairs of rollers. At this point, the product remaining in the chamber tumbles back to approximately the bottom of chamber 19 where it is once again picked up and carried upward along the inside surface of the chamber. This process repeats itself as the tumbling tomatoes 70 advance along the length of the sloped chamber from the inlet end to the discharge end.

As the product 70 to be sorted advances through chamber 19, soft, broken or undersized product 71 is grabbed by the counter-rotating pairs of rollers 69 and is pulled through the rollers and out of the chamber before it can advance through the entire length of the chamber to the discharge end. Whole and firm product 72, on the other hand, is not gripped by, and does not pass between, the counter-rotating pairs of rollers and remains in the chamber. The undamaged product 72 eventually exits out discharge end 13 of chamber 19 (see FIG. 2) where it is gathered for further processing.

The inventors have found that by varying the rotational speed of the sorting chamber and the rollers, a desired level of sorting can be achieved. For example, in one embodiment of the present invention used for sorting tomatoes, the chamber defined by 16 rollers and having a chamber radius of 13.6 inches (measured from axis 25 to axes 33), rotates at about 27 rpms about its axis 25. The rollers 18, which are attached to 3.2 inch pitch diameter pinion gears in this embodiment, rotate at 256.5 rpms about their own axes 33.

The rotational speed of chamber 19 about axis 25 is between 25-30 rpms in an alternative embodiment. In other embodiments, chamber 19 rotates at between 18-22 rpms, at between 15-35 rpms, or at rotational speeds that are greater than or less than 35 rpms.

At some of these rotational speeds, substantially all of the product 70 introduced into the chamber will generally reside within approximately a ninety degree quadrant 73 of the chamber, namely between the bottom of the chamber at point “a” in FIG. 3 (e.g., 180 degrees from the top of the chamber, also six o'clock) and a point “b” (or “c” for counter-clockwise rotation) shown in FIG. 3 that is approximately half-way up the side of chamber 19 (approximately +/− 90 degrees from the top of the chamber, also referred to as three or nine o'clock, depending on the direction of rotation of chamber 19). As a result, in this embodiment, soft food product is radially expelled from the chamber over only a 90 degree section of the chamber (e.g, a quarter of the chamber).

It should also be noted that the food product to be sorted in this embodiment remains in the lower half of chamber while the chamber rotates. Thus, soft food product expelled from the chamber is only expelled radially from the lower half of the chamber. No soft food product is expelled from the upper one-half of the chamber.

In another embodiment of the present invention, the food product to be sorted remains in the lower two-thirds of the chamber during rotation of the chamber and soft food product is only expelled radially from the lower two-thirds of the chamber No soft food product is expelled from the upper one-third of the chamber.

It should also be noted that the performance of sorting apparatus 10 can be adjusted through the selection of various types of rollers or brushes depending on the type and condition of the food product to be sorted. For example, the brushes that are used in one embodiment of the present invention for sorting tomatoes are shown in FIG. 9. These brushes have a brush core 80 with an outside diameter 83 of 3.5 inches. The channels 81 that hold the bristles to the core are spirally wound around the core (36 wraps per foot of channel on the core) and have a height 84 of 0.1875 inches in this embodiment. The bristles 82 are random length bristles made from polypropylene having a diameter of 0.018 inches. The maximum overall outside diameter of the brushes 85 used in this embodiment is 5.2188 inches.

The distance between adjacent brushes or rollers can also be adjusted to adjust the performance of the sorting apparatus for any given type of product. For the tomato sorting embodiment described herein (e.g., 16 brush rollers arranged around a chamber having a radius of 13.6 inches), for example, the tangent distance 86 between adjacent brush channels is approximately 1.4375 inches (see FIG. 9), Thus, soft, broken or undersized tomatoes having a diameter that is approximately equal to or less than 1.4375 inches should be able to pass through the rollers in this embodiment. In other embodiments, the distance between adjacent rollers 18 is less than or greater than 1.4375 inches, depending on the application and food product to be sorted.

Although the present invention is illustrated herein with roller brushes having a particular configuration, it should be understood that the present invention is not limited to this configuration or to these brushes and other types of brushes and rollers can be used. For example, in alternative embodiments, rollers 18 are not brushes, but rather are covered with some other type of gripping material such as rubber, neoprene rubber, rubber stripping, belt lagging or polyurethane. In other embodiments, rollers 18 are covered with a non-skid material or a material that provides for a rough roller surface. In yet other embodiments, some of the rollers have smooth or non-gripping surfaces.

It should also be noted that the present invention is not limited to spiral wound brushes. In other embodiments, other brush patterns are used including tuft patterns and fineset patterns. The bristles can also be made from other materials other than polypropylene including nylon, polypropylene polyester or polyethylene. The bristles can also be of different sizes (diameters) and do not need to be random in length.

In addition to the above, it should be noted that both brush rollers and gripping rollers can be combined in the same sorting apparatus. For example, in one embodiment, counter-rotating pairs of rollers include both a brush roller and a gripping roller. In other embodiments, counter-rotating pairs of rollers include both a gripping roller and a non-gripping roller (e.g, the roller has a smooth surface) or a brush roller and a non-gripping roller.

Numerous modifications may be made to the present invention which still fall within the intended scope hereof. Thus, it should be apparent that there has been provided in accordance with the present invention an apparatus and method of sorting soft food product from firm food product that fully satisfies the objectives and advantages set forth above. Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

The embodiments of the invention in which an exclusive property or privilege is claimed are defined as follows:

1. An apparatus for separating soft food product from firm food product, the apparatus comprising:
a rotatable cage having a chamber and a main axis of rotation, wherein the chamber rotates about the main axis of rotation;
a first roller having a second axis of rotation and radially disposed on the perimeter of the chamber, wherein the first roller orbits about the main axis of rotation with the chamber, and further wherein the first roller rotates about the second axis of rotation in a first direction; and
a second roller having a third axis of rotation and radially disposed on the perimeter of the cage adjacent to the first roller, wherein the second roller orbits about the main axis of rotation with the chamber, and further wherein the second roller rotates about the third axis of rotation in a second direction opposite to the first direction, wherein soft food product is removed from the rotating chamber by the first and second counter-rotating rollers.

2. The apparatus of claim 1 wherein the chamber has a product inlet opening at a first end of the chamber for receiving food product to be sorted.

3. The apparatus of claim 2 wherein the chamber has a product outlet opening at a second end of the chamber opposite the first end for delivering firm food product out of the chamber.

4. The apparatus of claim 3 wherein the main axis of rotation slopes downward from the inlet opening to the outlet opening

5. The apparatus of claim 3 further including a drive unit disposed to drive the rotatable cage.

6. The apparatus of claim 1 wherein the chamber has a product outlet opening for delivering firm food product out of the chamber.

7. The apparatus of claim 1 wherein the first and second rollers are each covered with a gripping material.

8. The apparatus of claim 1 wherein the first and second rollers are each brush rollers.

9. The apparatus of claim 1 wherein the first roller is covered with a gripping material and the second roller is a brush roller.

10. The apparatus of claim 1 wherein the first roller is a brush roller and the second roller is smooth.

11. An apparatus for sorting a food product, such as a fruit or vegetable, comprising:
a chamber;
a plurality of rollers radially spaced apart around the circumference of the chamber wherein each of the rollers includes a pinion gear;
a first ring gear wherein the first ring gear engages with every other one of the plurality of pinion gears to rotate every other one of the plurality of rollers in a first direction; and
a second ring gear wherein the second ring gear engages with the other ones of the plurality of pinion gears to rotate the other ones of the plurality of rollers in a second direction opposite to the first direction.

12. The apparatus of claim 11 wherein the first ring gear is an external ring gear.

13. The apparatus of claim 12 wherein the second ring gear is an internal ring gear.

14. The apparatus of claim 11 wherein the chamber includes a receiving end disposed to receive the food product to be sorted into the chamber.

15. The apparatus of claim 12 wherein the chamber further includes a discharge end disposed to deliver sorted food product out of the chamber.

16. An apparatus for sorting a food product, such as a fruit or vegetable, the apparatus comprising:
a first plurality of rollers radially disposed about a first axis of rotations each of the first plurality of rollers having a pinion gear attached thereto;
a second plurality of rollers radially disposed about the first axis of rotation, each of the second plurality of rollers having a pinion gear attached thereto, wherein the first and second plurality of rollers define a chamber for receiving the food product to be sorted;
a first ring gear, wherein the first ring gear engages with each of the pinion gears attached to the first plurality of rollers to impart rotation to the first plurality of rollers in a first direction; and
a second ring gear, wherein the second ring gear engages with each of the pinion gears attached to the second plurality of rollers to impart rotation to the second plurality of rollers in a second direction opposite to the first direction.

17. The apparatus of claim 16 wherein the first ring gear is an external ring gear.

18. The apparatus of claim 17 wherein the second ring gear is an internal ring gear.

19. The apparatus of claim 16 wherein the chamber has a product inlet opening at a first end for receiving food product to be sorted.

20. The apparatus of claim 19 wherein the chamber has a product outlet opening at a second end opposite the first end for delivering sorted food product out of the chamber.

21. An apparatus for sorting a food product such as a fruit or vegetable, wherein the apparatus sorts soft food product from firm food product, the apparatus comprising:
a cage having a chamber, wherein the chamber is rotatable about a main axis; and
a plurality of rollers radially spaced apart around the circumference of the chamber wherein adjacent rollers from the plurality of rollers rotate in opposite directions as the chamber rotates around the main axis to expel soft food product radially out of the chamber.

22. The apparatus of claim 21 wherein the chamber has a product inlet opening at a first end of the chamber for receiving food product to be sorted.

23. The apparatus of claim 22 wherein the chamber has a product outlet opening at a second end of the chamber opposite the first end for delivering firm food product out of the chamber.

24. The apparatus of claim 23 wherein the main axis slopes downward from the inlet opening to the outlet opening.

25. The apparatus of claim 23 further including a drive unit disposed to drive the rotatable chamber.

26. The apparatus of claim 21 wherein each of the plurality of rollers is covered with a gripping material.

27. The apparatus of claim 21 wherein each of the plurality of rollers is a brush roller.

28. The apparatus of claim 21 wherein adjacent pairs of rollers from the plurality of rollers include both a brush roller and a smooth roller.

29. The apparatus of claim 21 wherein adjacent pairs of rollers from the plurality of rollers include both a brush roller and a gripping roller.

30. An apparatus for sorting a food product such as a fruit or vegetable, wherein the apparatus sorts soft food product from firm food product, the apparatus comprising a plurality of rotatable rollers arranged in radially spaced-apart relationship about a main axis of rotation so as to define a chamber for receiving the food product to be sorted, wherein each of the plurality of rollers orbits about the main axis of rotation, and further wherein each of the plurality of rollers has its own axis of rotation, wherein adjacent rollers from the plurality of rollers rotate about their own axis of rotation in opposite directions to remove soft food product from the chamber.

31. An apparatus for sorting a food product, such as a fruit or vegetable, wherein the apparatus sorts soft food product from firm food product, the apparatus comprising a product sorting chamber rotatable about a main axis wherein the chamber is configured to expel substantially all of the soft food product radially outward from the chamber as the chamber rotates.

32. The apparatus of claim 31 wherein the chamber further includes a discharge end, wherein the chamber is configured to discharge substantially all of the firm food product out of the chamber through the discharge end as the chamber rotates.

33. The apparatus of claim 31 further comprising an inlet opening at a first end of the chamber for receiving food product to be sorted into the chamber.

34. The apparatus of claim 33 further comprising an outlet opening at a second end of the chamber opposite the first end for delivering firm food product out of the chamber.

35. An apparatus for sorting a food product, such as a fruit or vegetable, wherein the apparatus sorts soft food product from firm food product, the apparatus comprising a generally cylindrical product sorting chamber rotatable about a main axis wherein the chamber is configured to expel at least 50 percent of the soft food product radially outward from the chamber as the chamber rotates.

36. The apparatus of claim 35 wherein the chamber further includes a discharge end, wherein the chamber is configured to discharge firm product out of the chamber through the discharge end as the chamber rotates.

37. A method of sorting a food product, such as a fruit or vegetable, wherein soft food product is separated from firm food product, the method comprising:
introducing the food product to be sorted into a rotating chamber; and
expelling soft food product out of the rotating chamber between first and second counter-rotating rollers radially disposed about the rotating chamber.

38. The method of claim 37 further comprising delivering firm food product out of an end of the rotating chamber.

39. The method of claim 37 wherein the chamber rotates at a speed in the range of 25 to 30 revolutions per minute.

40. The method of claim 37 wherein the chamber rotates at a speed less than 35 revolutions per minute.

41. A method of sorting a food product, such as a fruit or vegetable, wherein soft food product is separated from firm food product, the method comprising:
rotating a chamber having a receiving end and a discharge end;
introducing the food product to be sorted into the chamber at the receiving end;
allowing the firm food product to pass out of the chamber at the discharge end; and
allowing the soft food product to pass out of the chamber through counter-rotating rollers radially disposed around the circumference of the chamber.

42. The method of claim 41 wherein the chamber rotates at a speed in the range of 25 to 30 revolutions per minute.

43. The method of claim 41 wherein the chamber rotates at a speed less than 35 revolutions per minute.

44. A method of separating soft food product from firm food product comprising:
passing soft food product through a pair of counter-rotating rollers as the pair of counter-rotating rollers orbit in a 360 degree path about a central axis of rotation.

45. A method of separating soft food product from firm food product comprising:
rotating a chamber about a main axis;
introducing the food product to be sorted into the chamber;
expelling substantially all of the soft food product radially out of the chamber.

46. The method of claim 45 further comprising introducing the food product to be sorted into a receiving end of the chamber.

47. The method of claim 46 further comprising discharging the firm food product out of a discharge end of the chamber.

48. The method of claim 45 further comprising discharging substantially all of the firm food product out of a discharge end of the chamber.

49. The method of claim 45 wherein the soft food product is radially expelled from only the lower one-half of the chamber as the chamber rotates.

50. The method of claim 45 wherein the soft food product is radially expelled from only the lower two-thirds of the chamber as the chamber rotates.

51. The method of claim 45 wherein the soft food product is radially expelled from the chamber as the chamber rotates at less than 35 revolutions per minute.
